(19) United States
(12) Patent Application Publication
(10) Pub. No.: US 2010/0151800 A1
(43) Pub. Date: Jun. 17, 2010

(54) COMMUNICATION DEVICE AND COMMUNICATION METHOD

(75) Inventors: Ippei Akita, Kawasaki-shi (JP); Takafumi Yamaji, Yokohama-shi (JP); Akihide Sai, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/558,784

(22) Filed: Sep. 14, 2009

(30) Foreign Application Priority Data
Dec. 17, 2008 (JP) 2008-320424

(51) Int. Cl. H04B 1/40; H04B 1/26

(52) U.S. Cl. 455/75; 455/318

(57) ABSTRACT

A communication device includes: a first oscillator to generate a local signal based on a control signal for regulating at least one of phase oise and jitter in the local signal; a frequency converter to convert a first signal having first frequency to a second signal having second frequency by using the local signal; a filter to remove undesired signal component from the second signal and output a third signal; and a controller to generate the control signal based on the second signal and the third signal.

### CROSS-REFERENCE TO RELATED APPLICATIONS

This application is based upon and claims the benefit of priority from the prior Japanese Patent Application No. 2008-320424, filed on Dec. 17, 2008; the entire contents of which are incorporated herein by reference.

### BACKGROUND OF THE INVENTION

1. Field of the Invention

The present invention relates to a communication device and a communication method such as a radio communication device and a radio communication method realizing a reduction in power consumption.

2. Description of the Related Art

In a radio receiver, in order to generate a local oscillation signal (local signal) for frequency conversion and a clock signal for an ADC (Analog to Digital Converter), a PLL (Phase Locked Loop) circuit including a VCO (Voltage Controlled Oscillator) and so on is used. In the PLL circuit, phase noise within a desired band is lowered but noise outside the desired band is decided mainly by phase noise of the oscillator itself included in the PLL circuit.

The specifications of the phase noises within and outside the band of the PLL circuit are decided according to various kinds of radio communication standards. However, when a ring oscillator or the like is used as the oscillator of the PLL circuit for the purpose of an area reduction, the more the phase noise is reduced, the more power the oscillator consumes (Behzad Razavi, “A Study of Phase Noise in CMOS Oscillators”, IEEE JOURNAL OF SOLID-STATE CIRCUITS, IEEE, VOL. 31, No. 3, MARCH 1996, p. 331).

### BRIEF SUMMARY OF THE INVENTION

As described above, the conventional communication device and communication method have the problem that power consumption becomes relatively large when the phase noise including those outside the desired band is optimized. The present invention was made to solve such a problem, and has an object to provide a communication device and a communication method capable of optimizing power consumption and phase noise of an oscillator.

To attain the above object, a communication device according to an aspect of the present invention includes: a first oscillator to generate a local signal based on a control signal for regulating at least one of phase noise and jitter in the local signal; a frequency converter to convert a first signal having first frequency to a second signal having second frequency by using the local signal; a filter to remove undesired signal component from the second signal and output a third signal; and a controller to generate the control signal based on the second signal and the third signal.

### BRIEF DESCRIPTION OF THE DRAWINGS

FIG. 1 is a block diagram showing a receiver according to a first embodiment.

FIG. 2 is a block diagram showing the receiver according to the first embodiment.

FIG. 3A is a chart showing how an adjacent channel is removed by the receiver of the first embodiment.

FIG. 3B is a chart showing how the adjacent channel is removed by the receiver of the first embodiment.

FIG. 3C is a chart showing how the adjacent channel is removed by the receiver of the first embodiment.

FIG. 4A is a chart showing a spectrum of a reception signal input to a mixer 30 of the receiver 1 and a spectrum of the reception signal output from a CSF 60 when a signal level of an adjacent channel is high.

FIG. 4B is a chart showing a spectrum of a reception signal input to the mixer 30 of the receiver 1 and a spectrum of the reception signal output from the CSF 60 when a signal level of an adjacent channel is low.

FIG. 5 is a block diagram showing a receiver 2 according to a second embodiment.

FIG. 6 is a block diagram showing a modification example of a CSF and a detector according to the first and second embodiments.

FIG. 7 is a chart illustrating the operation of the CSF and the detector shown in FIG. 6.

FIG. 8 is a block diagram showing a modification example of the CSF and the detector according to the first and second embodiments.

FIG. 9 is a block diagram showing a receiver 3 according to a third embodiment.

FIG. 10 is a block diagram showing a receiver 4 according to a fourth embodiment.

FIG. 11 is a block diagram showing a modification example of a local oscillator.

FIG. 12 is a diagram showing a concrete example of the local oscillator in the first to fourth embodiments.

### DETAILED DESCRIPTION OF THE INVENTION

Hereinafter, embodiments of a radio receiver according to the present invention will be described with reference to the drawings.

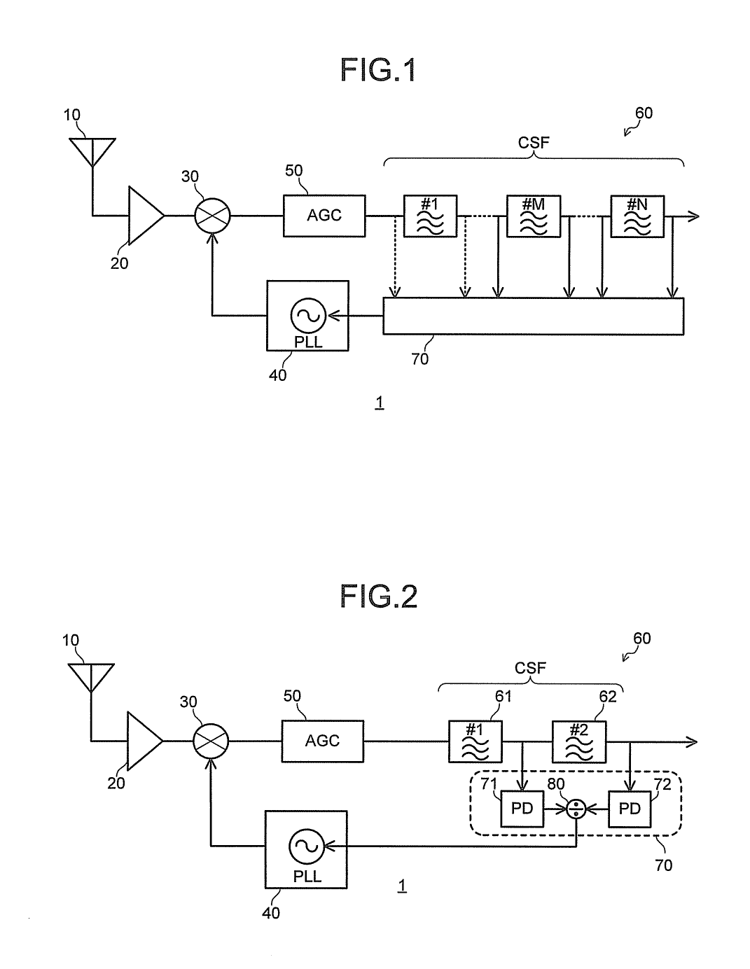

(First Embodiment) As shown in FIG. 1, a receiver 1 of this embodiment includes an antenna 10, a LNA (Low Noise Amplifier) 20, a frequency converter (mixer) 30, a local oscillator 40, an AGC (Auto Gain Control) 50, a CSF (Channel Select Filter) 60, and a detector 70.

The antenna 10 receives a radio wave received by the receiver 1 of this embodiment. The LNA 20 amplifies a high-frequency signal received by the antenna 10 to a predetermined level. The LNA 20 is desirably a high-frequency amplifier especially with low noise. The mixer 30 multiplies the reception signal amplified by the LNA 20 and a local signal to frequency-convert the reception signal, thereby generating a baseband reception signal.

The local oscillator 40 generates the local signal to provide it to the mixer 30. The local oscillator 40 is realized by, for example, a PLL circuit and is capable of adjusting the level of phase noise included in its output signal according to external control. The AGC 50 is realized by, for example, an amplifier including a feedback loop, and has a function of changing an amplifier gain according to the level of the reception signal converted to the baseband signal by the mixer 30. For example, in the gain control, the AGC 50 operates to decrease the amplifier gain when the level of the reception signal reaches a certain level or higher, thereby keeping the signal level substantially constant in order to prevent the distortion of the reception signal.

The CSF 60 is a multistage filter composed of N-stages of filters (N is a positive integer) connected in series. As shown in FIG. 1, the reception signal output from the AGC 50 is input to a first filter #1 forming the CSF 60 and an output of the first filter #1 is output to a second filter #2. After the second filter #2, the reception signal is filtered in the same manner by M-th filters #M. The reception signal having passed through the N-stages of filters is sent to a demodulator (not shown) or the like on a subsequent stage to be demodulated. The filters forming the CSF 60 have different pass characteristics, and a synthetic pass characteristic of the pass characteristics of all the filters is designed so as to allow the passage of only a desired signal (desired channel). Incidentally, the CSF GO maybe designed as N=1 so that a desired pass characteristic is obtained by one filter.

The detector 70 detects powers of input signals and output signals of the filters forming the CSF 60. Among the filters forming the CSF 60, the filter on the first stage may be set as a pre-filter to be excluded from targets of the detection by the detector 70. This can facilitate the design of the filters. In this case, a filter having a relatively broad characteristic is selected as the pre-filter. The detector 70 has a function of generating a control signal controlling a quality of the local signal, e.g. a phase noise level and/or a jitter of the local oscillator 40, based on the detected input signals and output signals of the filters to provide the control signal to the local oscillator 40. Here, the “power (level)” of a signal means an average power or an effective value of the signal but in the description below, this term is used as a wide concept including intensity of the signal. Incidentally, the detector 70 may detect magnitudes of amplitudes of the input signals and the output signals of the filters forming the CSF 60, instead of the powers of the input signals and the output signals thereof.

In this manner, in the receiver 1 of this embodiment, the phase noise level of the local oscillator 40 is controlled based on the input signals and the output signals of the filters forming the CSF 60. The CSF 60 is capable of cutting a signal of an adjacent channel, which means that the receiver 1 of this embodiment is capable of controlling the phase noise level of the local oscillator 40 according to the level of an interference wave from the adjacent channel. That is, when a difference in power between the input and output signals detected by the detector 70 is large, it indicates small noise ascribable to the interference wave from the adjacent channel and therefore the phase noise level of the local signal can be lowered. On the other hand, when the difference in power between the input and output signals detected by the detector 70 is small, it indicates that noise ascribable to the interference wave from the adjacent channel is large and therefore the phase noise level of the local signal needs to be made higher. The control of the phase noise level of the local signal generated by the local oscillator 40 directly influences an increase/decrease in power consumption, and as a result, it is possible to reduce the power consumption to a minimum required amount.

Hereinafter, the receiver 1 of this embodiment will be described, taking, as an example, a case where N=2 and M=2 as shown in FIG. 2 for simplification of the description. FIG. 2 shows a simplified structure in which N=2 and M=2 in the structure of the receiver 1 shown in FIG. 1, and common elements are denoted by the same reference numerals and symbols. Further, in FIG. 2, a first filter 61 forming the CSF 60 is set as a pre-filter to be excluded from targets of the detection by the detector 70, and the detector 70 detects only an input signal and an output signal of a second filter 62.

As shown in FIG. 2, the detector 70 of this embodiment includes PDs (Power Detectors) 71 and 72 and a divider 80. The PD 71 detects a power level of the input signal of the second filter 62 and the PD 72 detects a power level of an output signal of the second filter 62. The divider 80 divides the input signal level (the power level of the input signal) detected by the PD 71 by the output signal level (the power level of the output signal) detected by the PD 72 to output the result as a control signal. The control signal output by the divider 80 is input to the local oscillator 40.

Next, the operation of the receiver 1 of this embodiment will be described. A radio signal received by the antenna 10 is converted to an electric signal (reception signal) and the LNA 20 amplifies the reception signal to a predetermined level. The mixer 30 multiplies the reception signal by the local signal generated by the local oscillator 40 to convert the reception signal to a baseband reception signal. The AGC 50 adjusts the baseband reception signal to an appropriate level to input the resultant to the CSF 60.

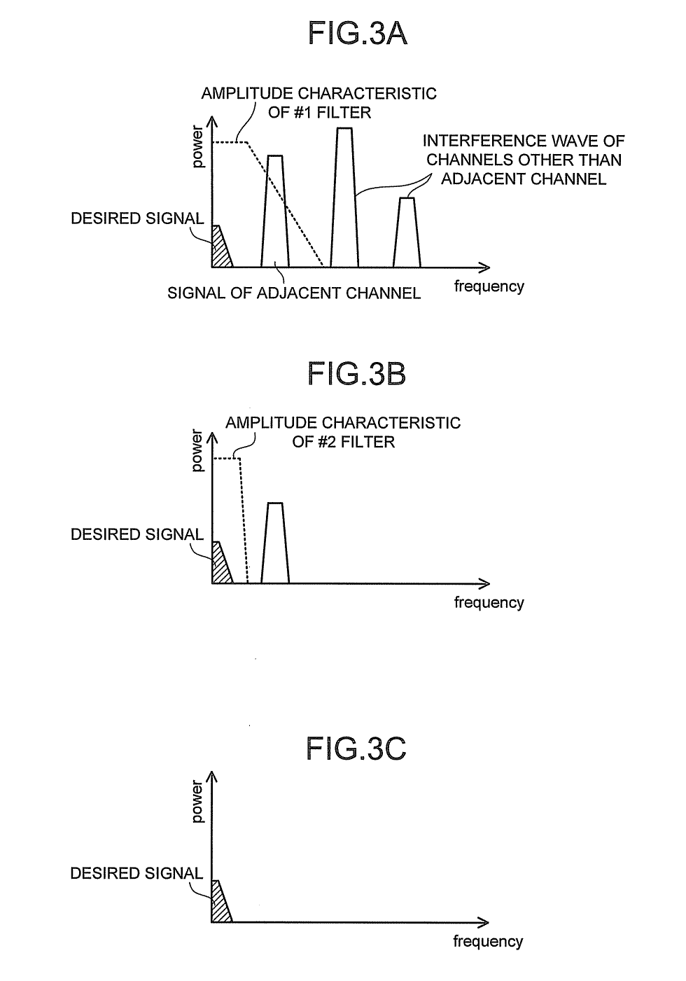

The reception signal input to the CSF 60 is first input to the first filter 61. The first filter 61 filters the reception signal with a characteristic shown by the broken line in FIG. 3A, for instance. As shown in FIG. 3A, assuming that the reception signal output from the AGC 50 includes a desired signal, a signal of an adjacent channel, and interference waves of channels other than the adjacent channel, the first filter 61 cuts all the interference waves of the channels other than the adjacent channel and part of the signal of the adjacent channel.

The output signal of the first filter 61 is input to the second filter 62. The second filter 62 filters the reception signal with a characteristic shown by the broken line in FIG. 3B, for instance. The reception signal input to the second filter 62, as a result of the filtering by the first filter 61, includes the desired signal and part of the signal of the adjacent channel, and therefore, the second filter 62 removes undesired signal components, i.e. the whole signal of the adjacent channel. As a result, the output of the second filter 62 (=output of the CSF 60) includes only the desired signal as shown in FIG. 3C.

The detector 70 detects the powers of the input signal and the output signal of the second filter 62 and performs the division processing. At this time, assuming that the input signal is divided by the output signal, the larger a power difference between the input and output, the larger an obtained division value. The detector 70 provides the division result as the control signal to the local oscillator 40.

The local oscillator 40 regulates its own phase noise level (and/or jitter) according to the magnitude of the control signal. In this example, the larger the division value of the detector 70 (=the smaller the signal level of the adjacent channel), the larger the magnitude of the control signal, and therefore, as the control signal is larger, the local oscillator 40 controls the phase noise level of the local signal to higher. As a result, when the signal level of the adjacent channel is low, the phase noise level is set high, which enables a reduction in power consumption of the local oscillator 40.

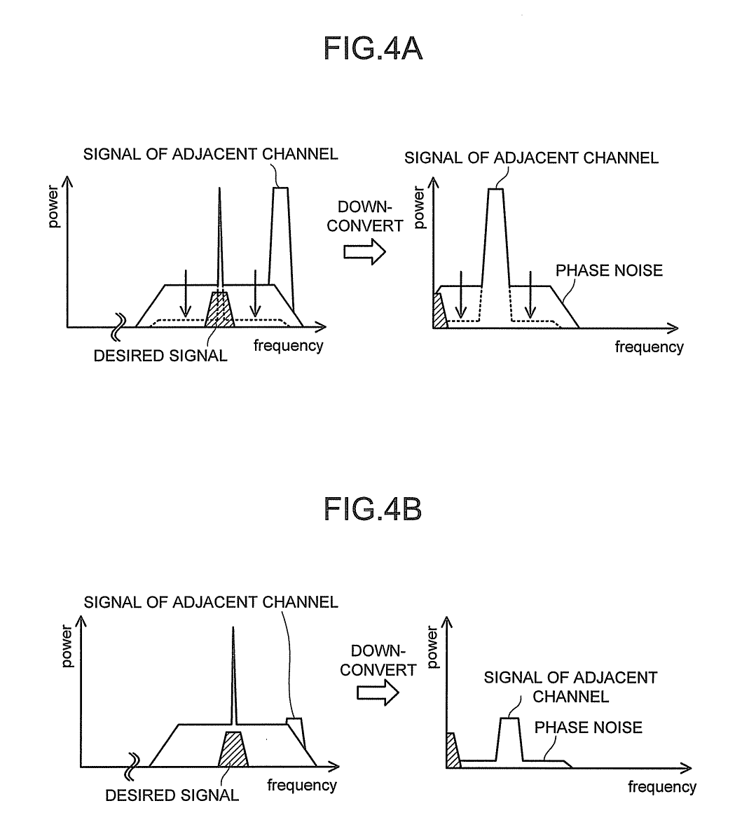

An operation principle of the receiver 1 of this embodiment will be described with reference to FIG. 4A and FIG. 4B.

In a frequency spectrum shown on the left side in FIG. 4A, a peak of a spectrum of a desired signal and a spectrum of a signal of an adjacent channel are shown, and further a spectrum of phase noise of a local signal generated by the local oscillator 40 is shown. It is understood that when a reception signal with this frequency spectrum is down-converted by the mixer 30, an interference wave component in which the signal of the adjacent channel and a phase noise component of the local signal are multiplied spreads around the signal of the adjacent channel, as shown on the right side in FIG. 4A. At this time, the interference wave component spreads up to a baseband region to affect the desired signal converted to the baseband. In this state, when the powers of the input and output signals of the second filter 62 are detected, a level difference therebetween is small (the division value is small) due to the influence of the spreading interference wave component.

In such a case, the detector 70 gives the local oscillator 40 the control signal whose control is to lower the level of the phase noise included in the local signal of the local oscillator 40. As a result, power consumption in the local oscillator 40 increases but the level of the phase noise of the local signal is lowered to the level of the broken line portion in FIG. 4A, and as a result, the interference wave component is reduced to low, so that the desired signal converted to the baseband is normally output from the CSF 60.

On the other hand, in a frequency spectrum shown on the left side in FIG. 4B, a peak of a spectrum of a desired signal and a spectrum of a low-level signal of an adjacent channel are shown, and further a spectrum of phase noise of a local signal generated by the local oscillator 40 is shown. When a reception signal with this frequency spectrum is down-converted by the mixer 30, an interference wave component in which the signal of the adjacent channel and a phase noise component of the local signal are multiplied is kept at a relatively low level, as shown on the right side in FIG. 4B. That is, the interference wave component does not spread up to the baseband region and thus does not affect the desired signal converted to the baseband signal. In such a case, even if the phase noise level of the local signal is high to some extent, the desired signal is not greatly affected. In this state, when the powers of the input and output signals of the second filter 62 are detected, a level difference therebetween is large (the division value is large) since the influence of the interference wave component is small.

Therefore, the detector 70 gives the local oscillator 40 a control signal whose control is to make the level of the phase noise included in the local signal of the local oscillator 40 high. As a result, power consumption in the local oscillator 40 is reduced, so that the interference wave component at a permissible level and the desired signal converted to the baseband are output from the CSF 60.

According to the receiver of this embodiment, the desired signal and undesired signal (the signal of the adjacent channel, including the desired signal) are detected, and the phase noise (and/or jitter; herein after the same) of the local oscillator is controlled based on the detection result, which can optimize power consumption. In a case where the CSF 60 is of a three-stage type or more, by detecting a ratio of input and output signals of any of the filters forming the CSF 60, it is possible to control the phase noise level of the local oscillator, which can reduce power consumption. That is, since no filter for extracting only the signal of the adjacent channel is required (the desired signal may be included), it is possible to realize the detector with a simple structure, which can save a circuit area.

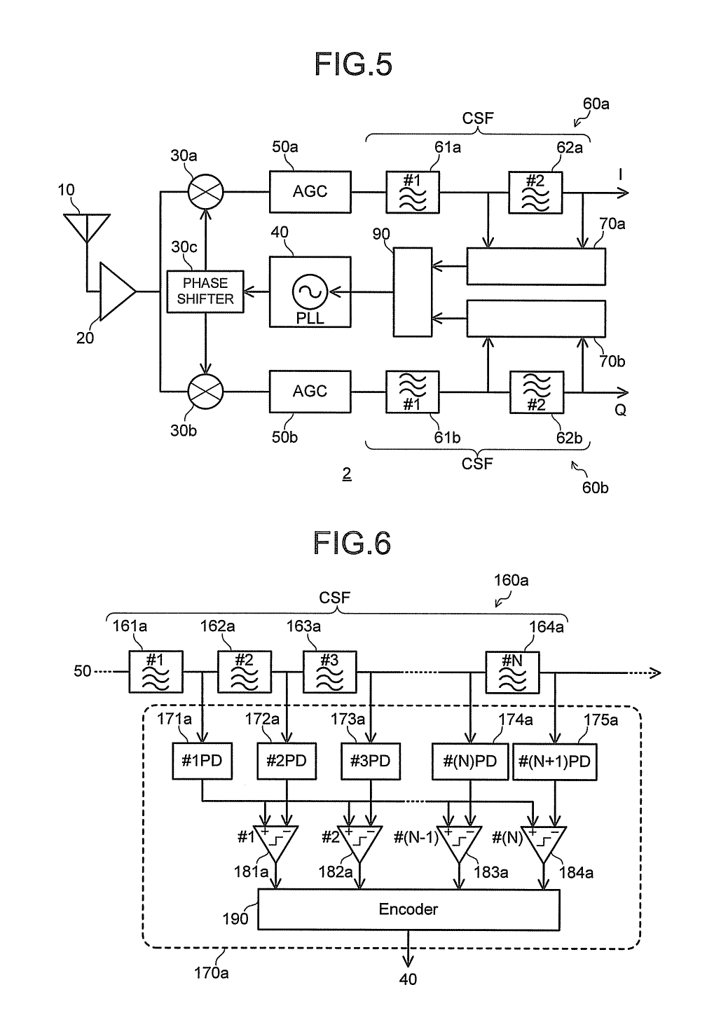

(Second Embodiment) Next, a receiver 2 according to a second embodiment of the present invention will be described in detail with reference to FIG. 5. The receiver 2 of this embodiment is structured such that the receiver 1 according to the first embodiment shown in FIG. 1 and FIG. 2 is adapted to quadrature modulation. Therefore, the same reference numerals and symbols are used to designate elements common to the receiver 1 of the first embodiment and repeated description thereof will be omitted. As shown in FIG. 5, the receiver 2 of this embodiment includes: mixers 30a and 30b which correspond to and have a similar function to that of the mixer 30; a phase shifter 30c dividing the local signal into two signals having a π/2 phase difference; AGCs 50a and 50b corresponding to and having a similar function to that of the AGC 50; CSFs 60a and 60b corresponding to and having a similar function to that of the CSF 60; detectors 70a and 70b corresponding to and having a similar function to that of the detector 70; and a multiplexer 90 giving the local oscillator 40 one of control signals output from the detectors 70a and 70b.

The phase shifter 30c divides the local signal generated by the local oscillator 40 and gives the resultant signals to the mixers 30a and 30b respectively, with the phase of one of the signals being changed by π/2. The mixers 30a and 30b multiply a reception signal amplified by a LNA 20 by the local signals resulting from the division by the phase shifter 30 with one of them being phase-shifted, and give the results to the AGCs 50a and 50b respectively. The CSFs 60a and 60b filter the reception signals level-adjusted by the AGCs 50a and 50b. The reception signal output from the CSF 60a becomes an I-channel signal and the reception signal output from the CSF 60b becomes a Q-channel signal.

The detectors 70a and 70b detect input and output signals of the filters forming the CSFs 60a and 60b respectively and give the multiplexer 90 the division values of power values of the input and output signals as control signals. The multiplexer 90 gives the local oscillator 40 the control signal for lowering the phase noise level of the local oscillator 40 more, out of the two control signals received from the detectors 70a and 70b. Consequently, it is possible to reduce power consumption of the local oscillator 40 while its phase noise level is constantly kept at a permissible level. That is, even when the I-channel signal and the Q-channel signal are different in power level, it is possible to maintain the quality of the desired signal.

Incidentally, when there is no great difference between the power level of the I-channel signal and the power level of the Q-channel signal, only one of the detectors 70a and 70b maybe disposed, without the multiplexer 90 provided. That is, when the power level of the I-channel signal and the power level of the Q-channel signal are about equal, the input and output signals of the filter forming one of the CSFs 60a and 60b are given to the detector 70a or 70b and a power ratio of a desired signal and an adjacent channel signal is detected. In such a case, since there is no need to prepare the detectors in both routes for the I-channel signal and the Q-channel signal, a mounting area of a substrate or the like can be saved.

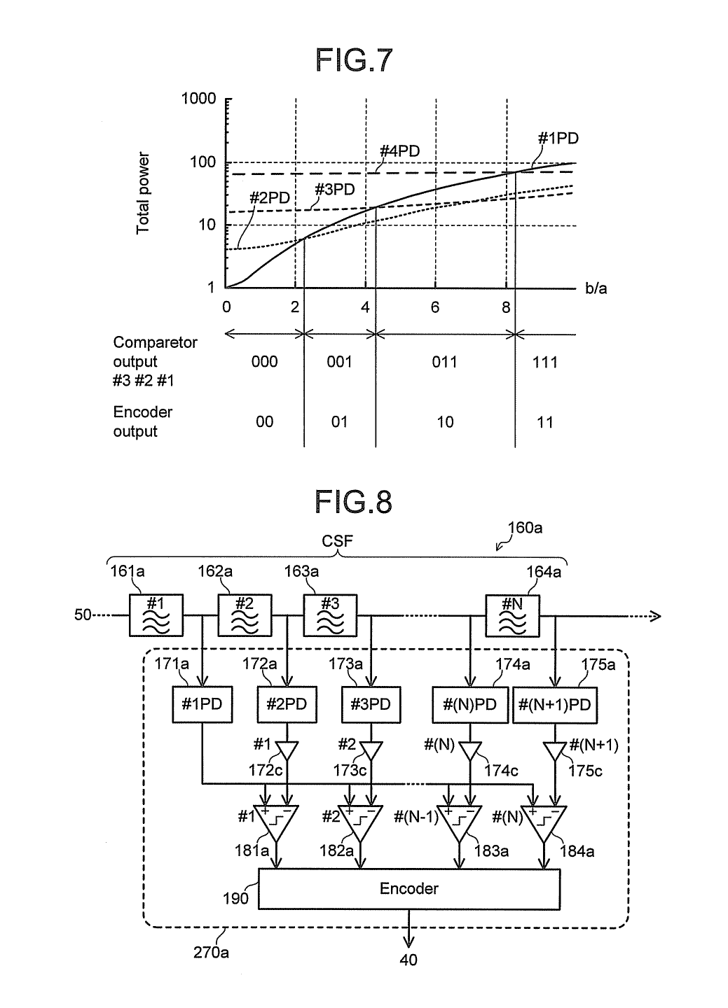

(Modification Example 1 of Detector) Here, a modification example of the CSF and the detector according to the receivers 1 and 2 according to the first and second embodiments will be described with reference to FIG. 6 and FIG. 7. In this modification example, the number of stages of the CSF is set to N (N is a positive integer) and the structure of the detector is changed. Therefore, the same reference numerals and symbols are used to designate common elements and repeated description thereof will be omitted.

A CSF 160a is a multistage filter composed of N-stages of filters (N is a positive integer) connected in series. It is assumed here that the filters forming the CSF each have an amplifier gain equal to 1 or more. As shown in FIG. 6, a reception signal output from the AGC 50 is input to a first filter 161a forming the CSF 160a and an output of the first filter 161a is input to a second filter 162a. An output of the second filter 162a is input to a third filter 163a, and thereafter, the reception signal is filtered by the filters up to an N-th filter 164a in the same manner. A detector 170a detects the input signal of the second filter 162a forming the CSF 160a and the output signals of all the filters forming the CSF 160a. Also in the CSF 160a, the filter on the first stage maybe set as a pre-filter to be excluded from detection targets.

More concretely, the detector 170a includes N+1 power detectors (PD), N comparators, and an encoder 190. A first PD 171a detects a power of the input signal of the second filter 162a, which is the reception signal before the filtering. The second PD 172a detects a power of the output signal of the second filter 162a, and the third PD 173a detects a power of the output signal of the third filter 163a. #(N+1) PD 175a on the N+1-th stage detects a power of the output signal of the N-th filter 164a.

Further, a first comparator 181a compares detection outputs of the first PD 171a and the second PD 172a respectively, and a second comparator 182a compares detection outputs of the first PD 171a and the third PD 173a respectively. That is, each of the comparators compares the detection output before the filtering and the detection output after the filtering by each of the filters forming the CSF. The comparison results of the first to N-th comparators 181a to 184a are input to the encoder 190.

The encoder 190 converts a thermometer code to a normal digital signal. Specifically, as shown in FIG. 6, each of the comparators compares the reception signal input to the CSF (more accurately, the output signal of the first filter as the pre-filter) and the output signal of each of the filters forming the CSF, and therefore, the outputs of the comparators when the number of the comparators arranged is N become an N-digit thermometer code. Then, the encoder 190 converts the N-digit thermometer code into, for example, a log2 (N+1)-bit digital signal or further to a D/A converted analog signal and gives it as a control signal for controlling the phase noise level of the local signal to the local oscillator 40.

Here, the operation of the CSF 160a and the detector 170a as the modification example will be described. In the description below, it is assumed that the amplifier gain of each of the filters forming the CSF is 2, an attenuation amount in the frequency of a signal of an adjacent channel relative to the frequency of a desired signal is an a multiple per stage of the filters forming the CSF. Further, it is assumed that interference waves of channels other than the adjacent channel have been removed by the first filter 161a.

If the desired signal is a sin wave with an amplitude a and the signal of the adjacent channel is a sin wave with an amplitude b, then, a total power input to the CSF 160a (output of #1PD) is given by

a²+b² (1), and

a total power (output of #(i+1) PD) after the passage of an i-th stage filter (i=2 to N) is given by

{Avⁱa}²+{(αAv)ⁱb}² (2).

FIG. 7 shows an example of the result of plotting the outputs of #1PD to #4PD vs. a ratio b/a of the amplitude a of the desired signal and the amplitude b of the signal of the adjacent channel, assuming that N=4, M=2, L(=N−1)=3, AV=2, and α=0.32 (−10 dB).

Next, the #1 to #3 comparators compare the outputs of #2 PD to#4 PD respectively with the output of #1 PD, and when the comparison target output is larger than the output of #1 PD, each of the comparators outputs “1”. Specifically, as shown in FIG. 7, the outputs of the comparators 183a, 182a, 181a are, for example, “000”, “001”, or “011”. These output results are converted to two-bit digital values by the encoder 190.

By such an operation, the detector 170a is capable of outputting the detection result according to a power ratio between the desired signal and the signal of the adjacent channel. Further, a threshold value of b/a above which the output of each of the comparators changes can be arbitrarily decided based on a gain Aᵥᵢ of an i-th stage filter and an attenuation amount (i of the adjacent channel (i=1 to N). Resolution of the detected b/a can be enhanced by increasing the number of stages N of the filters forming the CSF 160a.

In the CSF and the detector according to this modification example, the total powers of the inputs of the N-stage filters each having a gain larger than 1 and the total power of the output are compared, which makes it possible to detect, in effect, the intensity of the signal of the adjacent channel. That is, it is possible to find a ratio of the intensity of the desired signal and the intensity of the signal of the adjacent channel without using a divider, which can realize a reduction in area.

(Modification Example 2 of Detector) Here, another modification example of the CSF and the detector of the receivers 1 and 2 according to the first and second embodiments will be described with reference to FIG. 8. In this modification example, the number of stages of the CSF is set to N (N is a positive integer), and amplifiers amplifying outputs of the power detectors detecting the output signals of the filters forming the CSF are provided. Therefore, the same reference numerals and symbols are used to designate common elements and repeated description thereof will be omitted.

The CSF 160a and the detector 170a of the modification example shown in FIG. 6 are provided on the premise that the filters forming the CSF have the amplifier gains. However, when the filters forming the CSF are passive filters or the like having minus gains, the detection outputs of the reception signals before and after the filtering cannot be simply compared. A CSF 160a and a detector 270a of the modification example shown in FIG. 8 are structured such that amplifiers 172c . . . amplifying the outputs of the second PD 172a . . . detecting the output signals of the filters forming the CSF are inserted, thereby compensating signal attenuation by the filters forming the CSF.

This modification example can exhibit the same functions as those of the CSF and the detector shown in FIG. 6 and FIG. 7 even if the filters forming the CSF each have a gain of 1 or less.

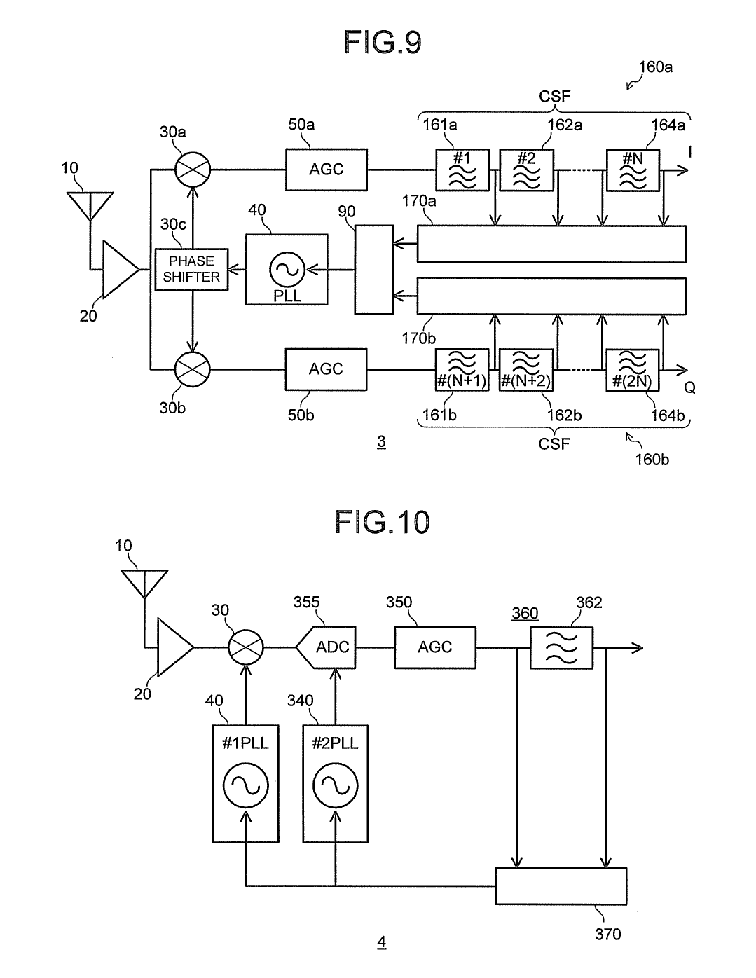

(Third Embodiment) Next, a receiver 3 according to a third embodiment of the present invention will be described in detail with reference to FIG. 9. In the receiver 3 of this embodiment, the CSFs 60a and 60b and the detectors 70a and 70b of the receiver 2 according to the second embodiment shown in FIG. 5 are replaced by the CSF 160a according to the modification example shown in FIG. 6 and a CSF 160b having the same structure and the detector 170a according to the modification example shown in FIG. 6 and a detector 170b having the same structure. That is, it is possible to obtain the same effect also in a radio system using quadrature modulation by using the multistage CSF and detector. It goes without saying that the use of the detector 270a in place of the detectors 170a and 170b can produce the same effect.

(Fourth Embodiment) Next, a receiver 4 according to a fourth embodiment of the present invention will be described in detail with reference to FIG. 10. The receiver 4 of this embodiment is structured such that in the receiver 1 of the first embodiment shown in FIG. 2, an A/D converter 355 (ADC 355) is disposed between the mixer 30 and the AGC 50, and a clock oscillator 340 giving a clock signal to the ADC 355 is provided in addition to the local oscillator 40 giving the local signal to the mixer 30. Therefore, the same reference numerals and symbols are used to designate elements common to the receiver 1 according to the first embodiment, and repeated description thereof will be omitted. The receiver 4 of this embodiment includes the clock oscillator 340, the ADC 355, an AGC 350, filters 362 forming a CSF 360, and a detector 370.

The ADC 355 converts a reception signal converted to a baseband signal by the mixer 30 into a digital reception signal. The clock oscillator 340 generates the clock signal for the A/D conversion to supply it to the ADC 355. The clock oscillator 340 has the same structure as the local oscillator 40 and is capable of changing a phase noise level included in the clock signal that it generates, according to external control.

The AGC 350 corresponds to the AGC 50 according to the first embodiment and performs auto gain control processing on a digital signal base. The CSF 360 and the filters forming the CSF correspond to the CSF 60 and the second filter 62 forming the CSF according to the first embodiment respectively, and have the same function except in that it digitally performs the processing.

The detector 370 corresponds to the detector 70 in the first embodiment and has the same function except in that its processing is digital processing. Further, the detector 370 is also different from the detector 70 of the first embodiment in that it generates not only the control signal controlling the phase noise level of the local oscillator 40 but also a control signal controlling the phase noise level of the clock oscillator 340. That is, based on an input signal and an output signal of the filter 362, the detector 370 generates the control signal controlling the phase noise level included in the local signal and the control signal controlling the phase noise level included in the clock signal and supply these control signals to the local oscillator 40 and the clock oscillator 340 respectively. The detector 370 digitally realizes the function of the detector 70 having the structure shown in FIG. 2, but may digitally realize the functions of the detectors 170a and 270a as the modification examples shown in FIG. 6 and FIG. 8.

The phase noise of the clock signal required by the ADC and the phase noise of the local signal required by the mixer have the same tendency in the relation between the required quality and power consumption, and therefore, it is effective not only to control the phase noise level of the local signal as is done in the receivers 1 to 3 according to the first to third embodiments but also to control the phase noise level of the clock signal for the ADC. That is, also in the receiver 4 of this embodiment, it is possible to reduce power consumption to a minimum required amount according to a signal level or the like of an adjacent channel. Further, the detector 370 of this embodiment performs digital processing, and thus need not include power detectors unlike the detectors 70, 170, 270 of the first to third embodiments. This can reduce a mounting area. Incidentally, the detector 30, the ADC 355, the AGC 350, the filter 362, and the detector 370 may be provided in two pairs as shown in FIG. 5 and FIG. 9 to be applied to a quadrature modulation type.

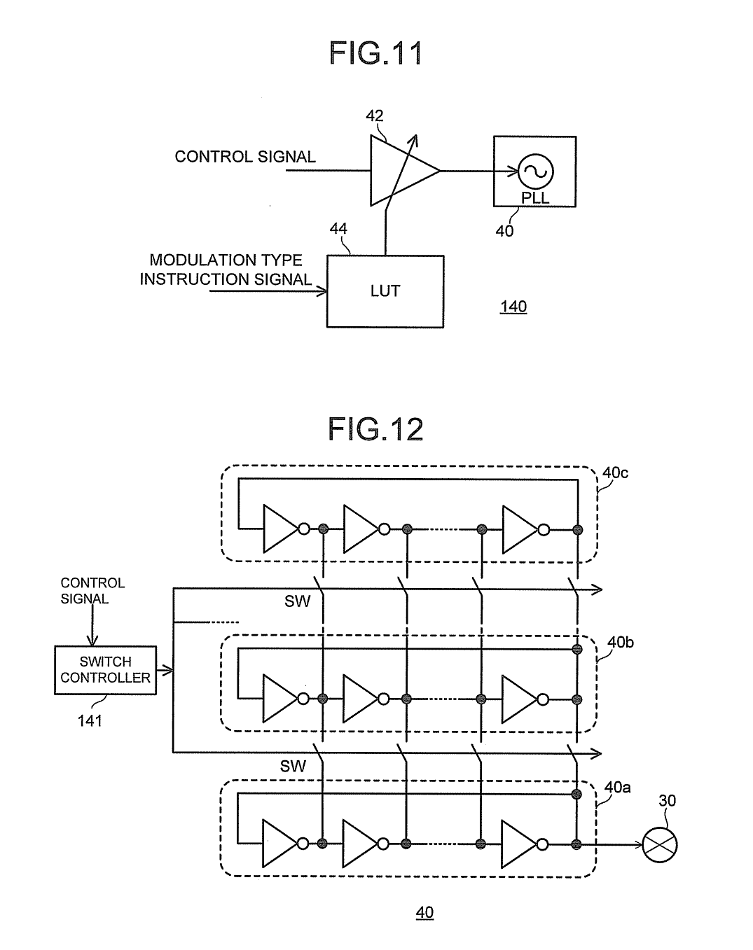

(Modification Example of Local Oscillator) Next, a modification example of the local oscillator in the first to fourth embodiments will be described with reference to FIG. 11. A local oscillator 140 shown in FIG. 11 is structured such that a variable gain amplifier 42 (VGA) and a lookup table 44 (LUT) are added to the local oscillator 40 shown in FIG. 2. Therefore, in FIG. 11, the same reference numerals and symbols are used to designate common elements, and repeated description thereof will be omitted.

The VGA 42 is capable of adjusting its amplifier gain according to external control, and amplifies the control signal generated by the detector or the multiplexer of the first to fourth embodiments. The LUT 44 stores a table showing a correspondence relation between a transmission type (for example, a modulation type used for communication) and an amplifier gain to be taken by the VGA 42 (or a value of the control signal to be given to the local oscillator 40, a value of the phase noise level of the local signal to be generated by the local oscillator 40, or the like), and controls the amplifier gain of the VGA 42 based on an external instruction signal. That is, upon receiving the external instruction signal regarding the transmission type, the LUT 44 selects an amplifier gain corresponding to the transmission type included in the instruction signal to control the amplifier gain of the VGA 42. The VGA 42 amplifies the control signal with the amplifier gain selected by the LUT 44 to give the resultant to the local oscillator 40.

According to the local oscillator 140 shown in FIG. 11, phase noise level control taking information on the transmission type into consideration is made possible. The required phase noise level of the local oscillator differs depending not only on the intensity of a signal of an adjacent channel but also on a modulation type such as QPSK or 16 QAM used in communication. Therefore, by using the information on the kind of the used modulation type for the control of the phase noise of the oscillator as well, it is possible to realize a more delicate reduction in power consumption. Incidentally, in the example shown in FIG. 11, the VGA 42 and the LUT 44 are added to the local oscillator 40, but this structure is not restrictive. Applying them to the clock oscillator 340 shown in FIG. 10 can also produce the same effect.

(Structure Example of Local Oscillator) Next, an example of the local oscillator in the first to fourth embodiments will be described with reference to FIG. 12.

As shown in FIG. 12, a local oscillator 40 of this example includes ring oscillators 40a to 40c each having serially connected inverters. The ring oscillator 40a feeds an output signal of the inverter on the final stage (inverter closest to its output side among the serially connected inverters) back to the inverter on the first stage (inverter closest to its input side among the serially connected inverters). The ring oscillators 40a to 40c have a common structure and are connected in parallel via switches SW. That is, output ends of the inverters are connected to output ends of the corresponding inverters of the adjacent ring oscillators via the switches SW.

The opening/closing of the switches SW are controlled by a switch control signal from a switch control unit 141. Based on the control signal received from the detector or the multiplexer, the switch control unit 141 controls the connection of the switches SW to control the number of the ring oscillators connected in parallel. That is, when the control signal indicates the control to increase the phase noise level of the local signal, the switch control unit 141 decreases the number of the ring oscillators connected in parallel. In this case, the phase noise level increases and power consumption of the whole local oscillator is reduced. On the other hand, when the control signal indicates the control to lower the phase noise level of the local signal, the switch control unit 141 increases the number of the ring oscillators connected in parallel. In this case, the phase noise level lowers and power consumption of the whole local oscillator increases.

According to the local oscillator of this concrete example, it is possible to control the phase noise level and power consumption based on the external control signal. Further, owing to the use of the ring oscillators, the size of the device can be made small.

It should be noted that the present invention is not limited to the above-described embodiments in their entirety, but when carried out, the present invention may be embodied by modifying the constituent elements without departing from the spirit of the present invention. For example, in the above-described embodiments, what is called a direct conversion type converting the reception signal directly to the baseband signal is taken as an example, but this is not restrictive. For example, the present invention is also applicable to a receiver of another type such as a heterodyne receiver or the like, for instance. Further, the detector is described as detecting the power level using the power detectors, but as previously described, the detector may include amplitude detectors instead of the power detectors to detect the magnitudes of the amplitudes of the signal (voltage or current). The control of the generation of the control signal, the control of the phase noise level of the local oscillator and so on by such a detector may be performed at an appropriate timing manually or automatically. Further, various inventions can be formed by appropriate combination of the plural constituent elements disclosed in the above-described embodiments. For example, some of all the constituent elements shown in the embodiments may be deleted. Constituent elements in different embodiments may be appropriately combined. According to the embodiments of the present invention, it is possible to provide a communication device and a communication method capable of optimizing power consumption and phase noise of the oscillator.

What is claimed is:

1. A communication device, comprising:
a first oscillator to generate a local signal based on a control signal for regulating at least one of phase noise and jitter in the local signal;
a frequency converter to convert a first signal having first frequency to a second signal having second frequency by using the local signal;
a filter to remove undesired signal component from the second signal and output a third signal; and
a controller to generate the control signal based on the second signal and the third signal.

2. The communication device according to claim 1,
wherein the first oscillator generates the local signal whose phase noise level is controlled based on the control signal.

3. The communication device according to claim 1,
wherein the first oscillator includes ring oscillators connected in parallel and controls the number of the ring oscillators connected in parallel based on the control signal.

4. The communication device according to claim 1,
wherein the filter removes a signal of an adjacent channel from the second signal to output the third signal.

5. The communication device according to claim 1,
wherein the controller generates the control signal according to a ratio or a difference of powers of the second signal and the third signal.

6. The communication device according to claim 1,
wherein the controller includes:
a detector to detect powers of the second signal and the third signal respectively; and
a divider to divide the powers detected by the detector to generate the control signal.

7. The communication device according to claim 1, further comprising:
an A/D converter to convert the second signal from analog to digital based on a clock signal; and
a second oscillator to generate the clock signal based on the control signal,
wherein the controller further provides the control signal to the second oscillator.

8. The communication device according to claim 1, further comprising,
a transmission type controller to regulate at least one of phase noise and jitter in the local signal by further adjusting the control signal generated by the controller, based on a type control signal indicating a transmission type.

9. The communication device according to claim 1,
wherein the filter includes a plurality of serially connected sub filters having different pass characteristics, the sub filters outputting fourth signals; and
wherein the controller generates the control signal based on the second signal and one or more of the fourth signals.

10. The communication device according to claim 1,
wherein the filter includes a plurality of serially connected sub filters having different pass characteristics, the sub filters outputting fourth signals; and
wherein the controller includes:
a first detector to detect a power of the second signal;
a plurality of second detectors to detect powers of the fourth signals;
a plurality of comparators to compare a value of the power detected by the first detector and one value, out of different values of the powers detected by the second detector respectively; and
a converter to generate the control signal based on a string of comparison values output by the plural comparators.

11. A communication method, comprising:
generating a local signal by an oscillator capable of regulating at least one of phase noise and jitter in the local signal according to a control signal;
converting a first signal having first frequency to a second signal having second frequency by a frequency converter by using the local signal;
removing undesired signal component from the second signal and output a third signal;
detecting a power of the second signal and a power of the third signal by a detector; and
generating the control signal based on a ratio or a difference of the powers detected by the detector.
